(19) United States
(12) Patent Application Publication
(10) Pub. No.: US 2012/0047055 A1
(43) Pub. Date: Feb. 23, 2012

(54) Post end of life management system and method

(75) Inventor: Michael Eugene Aiello, North Palm Beach, FL (US)

(73) Assignee: LifeEnsured Inc., New York, NY (US)

(21) Appl. No.: 13/136,926

(22) Filed: Aug. 15, 2011

Related U.S. Application Data
(60) Provisional application No. 61/375,919, filed on Aug. 23, 2010.

(51) Int. Cl. G06Q 99/00; G06Q 40/00

(52) U.S. Cl. 705/35

(57) ABSTRACT

A post end of life management system and method comprising, registering and setting up directives to manage online accounts, digital data, and perform other functions by providers after the death of the registrant. The system is integrated with the social security administration to receive death notifications from the death master file as well as with the deceased individual registry counterparts of other countries. Registrant accounts are encrypted and stored in the system and triggered to decrypt in order to carry out directives left by the deceased after notification of death is received from the social security administration or the deceased individual registry counterpart of another country.

### CROSS-REFERENCE TO RELATED APPLICATIONS

This application claims priority to U.S. Provisional Patent Application No. 61/375,919 filed Aug. 23, 2010 which is incorporated herein in its entirety

### FIELD OF THE INVENTION

The present invention relates generally to the management of an individual's personal matters after he or she is deceased. More particularly, the invention relates to an online system that carries out directives left behind by an individual as to how and in what manner his or her online accounts with the various providers and entities should be managed in the event of their demise.

### BACKGROUND OF THE INVENTION

Benjamin Franklin once famously said, “In this world nothing can be said to be certain except death and taxes.” When a person dies, he or she leaves behind the remnants of their lives in various forms, whether they are personal or real property, insurance, bank accounts, loans, credit card debts as well as non tangible assets such as social networking site accounts such as face book accounts, MySpace accounts, twitter accounts, email accounts, flickr accounts etc.

Under the current systems available, once a person dies whether through natural causes or prematurely by accident or overcome by a disease, the various online accounts maintained by the individual while he or she was alive remain in a state of limbo and persist indefinitely, with the account providers having no knowledge of the individual's demise. In addition, members of social network sites such as face book, MySpace, flickr and other such sites on which the individual was active are left wondering what happened to their friend or network member and with no means to verify the reason for the member's inactivity on the site or communicate with them, may go through a period of anxiety, pain and despair. Online bank accounts, bill payments, investment accounts etc., also remain inactive after the person's demise. Accessing these accounts by the next of kin to manage and terminate the accounts becomes difficult and in some instances impossible because of passwords and other security control mechanisms set up for the various accounts by the deceased while alive, creating an administrative burden for the surviving family members.

Thus, there is a need for a system and method that is made available to an individual while he or she is alive to set up a way for his or her death to be detected as well as set up directives on how their online accounts both tangible and intangible should be managed after they are deceased. The present invention provides such a system and method.

### SUMMARY OF THE INVENTION

The present invention relates to an online system and method that allows an individual to set up directives on post life management of their online accounts both tangible and intangible after their death and carries out those directives after the person is deceased in a smooth and efficient manner. The personal information and directives of the registered individual are encrypted and stored in the system till the person dies at which point the files are decrypted to carry out the directives left behind by the individual. In this manner, an individual is empowered with the capability to predefine their intentions for these accounts in the event of their death which may involve instructions for changing or deleting accounts and arranging for other services after their death.

In an exemplary embodiment of the invention, the system of the invention is integrated with the social security administration to receive a copy of their death master file which is periodically matched with individuals registered with the system. In this embodiment, individuals register with the system and provide their social security number and details regarding the accounts they have with the various service providers and entities. In this embodiment, after registering and providing the required information, the individual can then set up directives for the manner in which their online accounts with the various service providers and entities such as bank accounts, investment accounts, credit card accounts, online payment accounts, email accounts, accounts with social networking sites such as face book, MySpace, twitter, and photo sites such as, flickr etc., should be managed in the event of their death. In this embodiment, user Id's and passwords to these accounts are encrypted and stored in the system and triggered to decrypt after notification of death is received from the social security administration. When an individual who has registered with the system dies and the death matches the death master file of the social security administration, the system decrypts the individual's encrypted files and executes the directives left by the deceased for managing and settling their online accounts with the various service providers and entities.

In yet another exemplary embodiment of the present invention, the system of the invention is integrated with various service providers and entities. In this embodiment, individuals desiring to set up post end of life directives need not directly register with the system. Rather, individuals may leave directives with providers and entities integrated with the system of the present invention for post end of life management of their accounts.

In another embodiment of the present invention, the individual registered with the system may also leave directives to specific providers or entities to perform functions unrelated to their accounts such as having a provider send flowers to a family member or send a document indicating that the individual has elected to donate their online content to charity after their death.

In yet another exemplary embodiment of the present invention, the system of the present invention is set up to receive notifications from the social security administration or deceased individual registry counter parts in other countries and carry out directives for post life management of accounts of individuals in those countries who are registered with the system.

The features and advantages of the embodiments thus described and objectives of the present invention will be more fully appreciated and become obvious to one skilled in the art when viewed in conjunction with the accompanying drawings, detailed description of the invention and the appended claims.

### BRIEF DESCRIPTION OF THE DRAWINGS

FIG. 1 is a flow chart depicting the general architecture and overview of the exemplary embodiment of the present invention.

FIG. 2 is a schematic diagram depicting the registration of online accounts with the system of the present invention.

FIG. 3 is a schematic flow diagram illustrating the configuration and management of the system and method of the present invention.

FIG. 4 is a schematic diagram of another embodiment of the present invention illustrating the provision for a non-registrant to the system of the present invention to leave directives with specific online account providers who are integrated with the system of the invention.

FIG. 5 is a flow chart depicting an alternate architecture and overview of an exemplary embodiment of the present invention.

### DETAILED DESCRIPTION OF THE INVENTION

The present invention is an online system and method that provides an avenue for end of life planning and management of digital data and online accounts of individuals after they are deceased. The system and method of the invention advantageously allows individuals while they are still alive to set up directives on how to manage their online accounts and stored digital data soon after their death. At the heart of the invention is the philosophy that memories and connections one creates online during one's lifetime are their digital assets and as trustees of that asset, one has a right to manage and dispose them off according to one's wishes at the time of death. Upon the death of a registrant to the system of the present invention, the system becomes the successor trustee of the deceased's digital assets to manage and dispose of those assets according to the directives and wishes of the deceased registrant.

In the exemplary embodiment of the present invention, the system of the invention is configured to receive notifications and updates from the social security administration's death master file. In this embodiment, individuals or entities register with the system of the present invention and set up directives on how and in what manner their online accounts and digital data should be managed upon their demise. This allows for the system rather than a family member, friend, or associate to take control of the online accounts and digital data of the deceased and perform the necessary actions with regard to those assets as proposed in the directives left with the system by the individual or entity. The system and method of the present invention transparently and seamlessly accomplishes the execution of the directives left by the deceased relieving the family or caregiver from the administrative burden of trying to gain access to the deceased's online information, accounts and assets that are password protected in order to delete or close accounts with the related service providers.

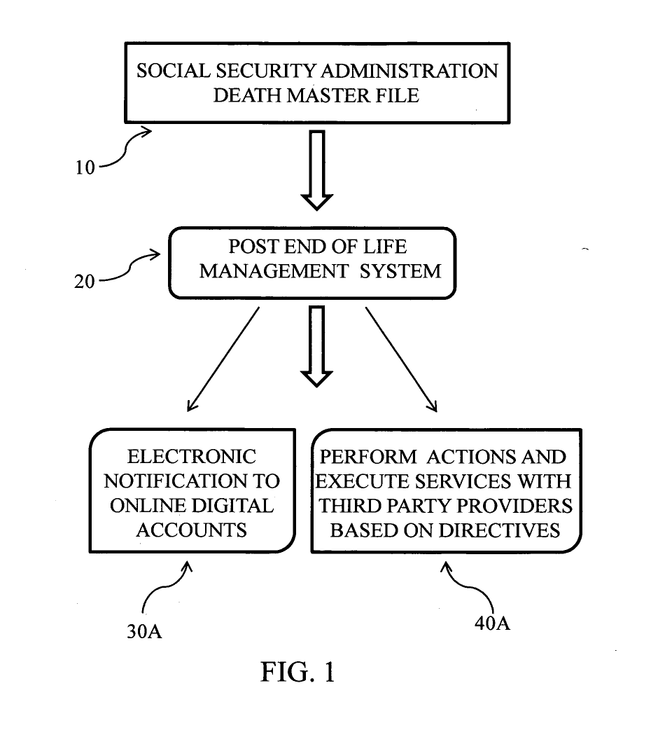

Referring now to the figures, more particularly to FIG. 1, a flow chart depicting the general architecture and overview of the exemplary embodiment of the present invention is shown. The post end of life management system 20 of the present invention is configured to communicate with the death master file 10 of the social security administration and receive updated death notifications. Upon receiving the notifications, the system 20 runs a check (by social security number) of the registrants in the system. If a registrant's name and social security number match that of a deceased in the death master file 10 of the social security administration, the system 20 reviews the list of directives left by the deceased during their lifetime and executes their wishes with reference to managing their online accounts by sending electronic notifications to online and digital data accounts 30A to close or delete the accounts. The system 20 also performs actions and executes services with third party providers based on directives 40A left by the deceased.

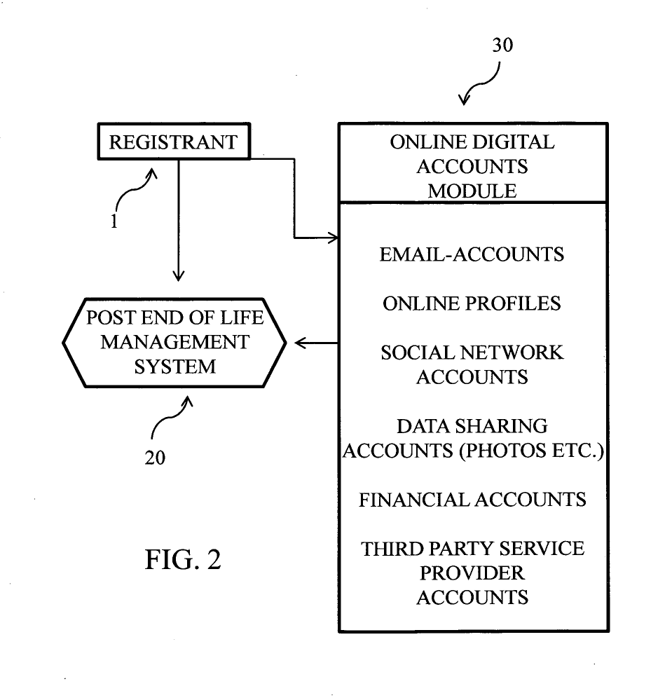

FIG. 2 is a schematic diagram depicting the registration of online accounts with the post end of life management system 20 of the present invention. In this embodiment, the registrant 1 registers with the system 20 using his or her social security number and enters information about their online digital accounts 30. The online accounts may be email accounts, social network accounts, other online profiles, data sharing accounts, financial accounts, third party service provider accounts etc. In this embodiment, the personal information and directives of the registered individual are encrypted and stored in the system till the person dies. Upon the death of registrant 1, the system 20 is configured to decrypt the directive files of registrant 1 to carry out the instructions and wishes of registrant lwith reference to the online accounts and digital data.

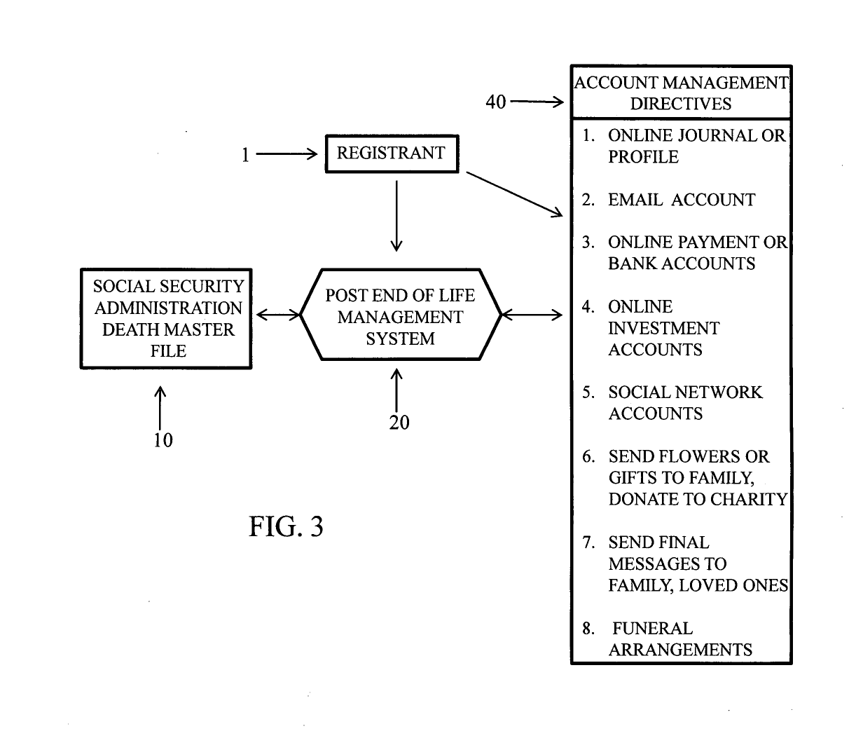

FIG. 3 is a schematic flow diagram illustrating the configuration and management of the system and method of the present invention. In this embodiment, after registrant 1 registers with the post end of life management system 20 and enters information about their online accounts and digital data, an account management directive 40 is set up with detailed instructions to system 20 on how to manage the various online accounts and execute services with third party providers. For instance, a directive may state that registrant 1 wishes to donate their online content to charity, send flowers to a particular family member, friend or associate, send final email messages to loved ones, friends or family, make funeral arrangements. Other directives may be to delete an online journal or profile, manage and close email and social networking accounts, notify online payment accounts such as PayPal accounts, bank accounts, investment accounts etc. The system 20 encrypts all directives from registrant 1 and decrypts the directives upon receiving notification through the death master file 10 of the social security administration that registrant 1 has died. System 20 verifies the passing of registrant 1 by the social security number provided and matching that number with the number recorded on the death master file 10 of the social security administration.

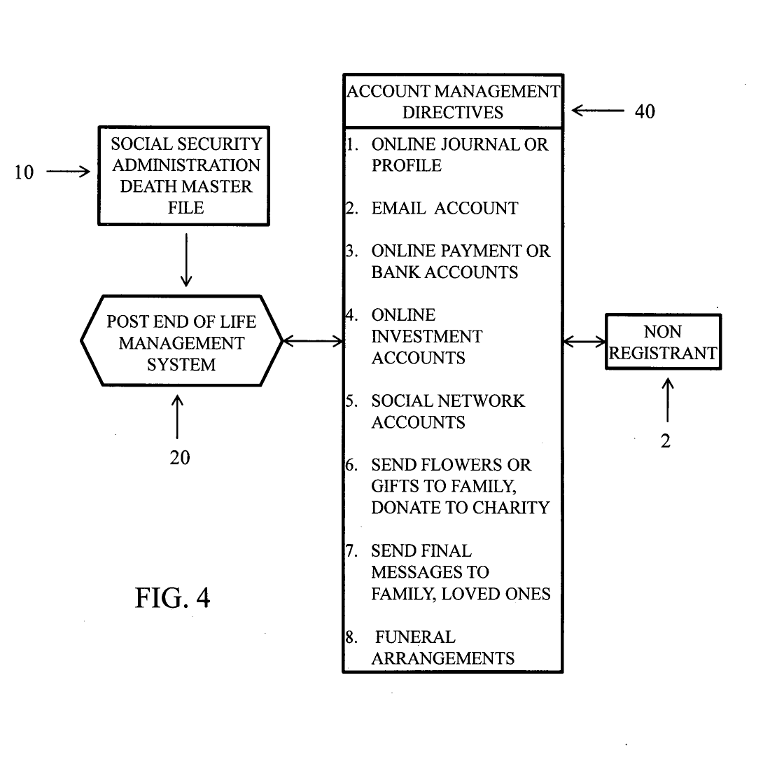

FIG. 4 is a schematic diagram illustrating another embodiment of the present invention. In this embodiment, a non-registrant 2 to the system 20 may leave directives with providers and entities integrated with the system of the present invention for post end of life management of their accounts. In this embodiment, individuals desiring to set up post end of life directives need not directly register with the system. Upon the death of the non-registrant 2 to the system, the third party providers with whom the non-registrant 2 has left directives 40 will communicate with the system 20 to carry out those directives. In this embodiment, the system 20 will verify the death of the non-registrant 2 through the death master file 10 of the social security administration before carrying out the directives of the deceased non-registrant 2.

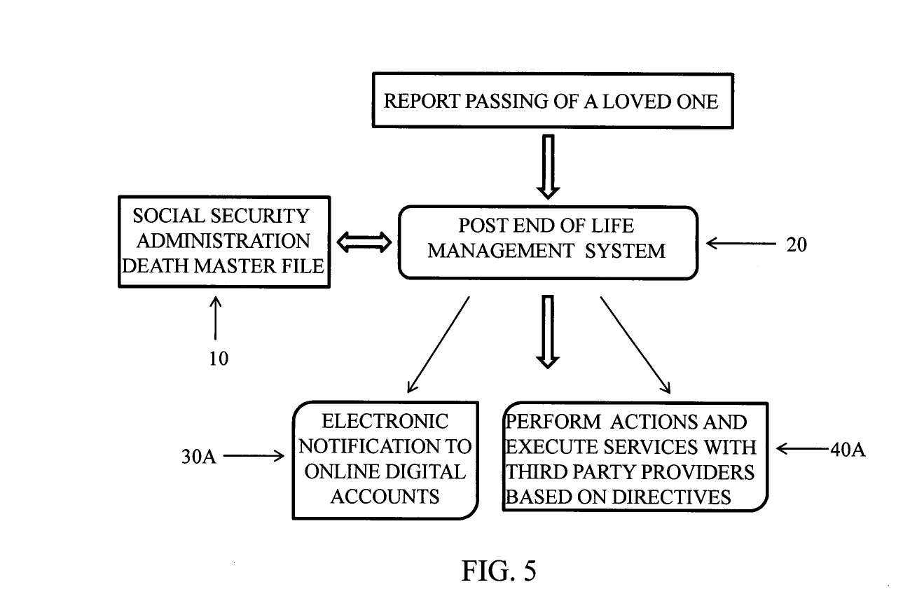

FIG. 5 is a flow chart depicting an alternate architecture and overview of an exemplary embodiment of the present invention. In this embodiment, the post end of life management system 20 of the present invention facilitates a family member, friend, or associate to communicate with the system about the loss of a loved one that may be registered with the system. In this embodiment, after the family, friend, or associate has notified the system of the passing, of their loved one, the system 20 verifies the passing of the registrant with the death master file 10 of the social security administration. Once verification of registrant's death is completed, the system 20 carries out the directives left by the registrant by sending out electronic notifications of the registrant's passing to the online digital accounts to close or delete the accounts and perform actions and execute services with third party providers according to the registrant's explicit wishes and instructions.

The foregoing description of the invention through its figures and preferred embodiments should not be construed to limit the scope of the invention. It should be understood that the invention can be carried out or practiced in diverse ways and that the invention can be implemented in embodiments other than the ones outlined in the description above. It should be understood and obvious to one skilled in the art that the embodiments thus described may be further modified without departing from the spirit and scope of the invention as set forth in the claims that follow.

What is claimed is:

1. An online system for post end of life management of online accounts and digital data, the system comprising:
a) a web page and database;
b) a means for creating a registrant profile;
c) a means for entering information about a plurality of online accounts;
d) a means for entering a plurality of online account management directives; and
e) a means for verifying the death of registrant.

2. The online system of claim 1 wherein the registrant profile is created with the social security number of the registrant.

3. The online system of claim 1 wherein the plurality of online accounts comprise, email accounts, online profile accounts, social network accounts, data sharing accounts, third part service provider accounts, financial accounts, online payment accounts, online investment accounts and other online accounts set up by the registrant while alive.

4. The online system of claim 1 wherein the information about the online accounts is encrypted while the registrant is alive and decrypted upon the registrant's death to notify the online account provider's of the registrant's death to carry out the directives left by the registrant to close or delete the accounts.

5. The online system of claim 1 wherein the plurality of online account management directives are set up by the registrant for post end of life management of the online accounts by the system.

6. The online system of claim 1 wherein the online account management directives are encrypted while the registrant is alive and decrypted upon the registrant's death to carry out the directives.

7. The online system of claim 1 wherein the directives may comprise, sending final messages to family, associates or loved ones, sending flowers or gifts to family and friends, instructions to donate online content to charity.

8. The online system of claim 1 wherein a non-registrant can leave directives with online account and other service providers who are integrated with the online system to carry out post end of life directives by the system.

9. The online system of claim 1 wherein the means for verifying the death of registrant is through the death master file of the social security administration by matching the social security number of the registrant with the social security number of the deceased listed in the death master file.

10. The online system of claim 1 wherein the means for verifying the death of registrant is through integration of the system with the social security administration or deceased individual registry counterparts of other countries.

11. The online system of claim 1 wherein a family member, friend, or associate may notify the system of the death of their loved one.

12. A method for post end of life management of online accounts and digital data, the method comprising the steps of
a) registering with the online post end of life management system;
b) entering information about the online accounts and digital data into the system;
c) configuring account management directives to be carried out after the death of registrant;
d) verifying the death of registrant from the death master file of the social security administration or the deceased individual registry counterpart of another country;
e) decrypting the account management directives;
f) notifying online digital account providers of the registrant's death; and
g) carrying out the directives of the deceased registrant.
